(19) United States
(12) Patent Application Publication
(10) Pub. No.: US 2009/0263039 A1
(43) Pub. Date: Oct. 22, 2009

(54) METHOD AND SYSTEM FOR IMPROVING VISUAL QUALITY OF AN IMAGE SIGNAL

(75) Inventors: Wilhelmus Hendrikus Alfonsus Bruls, Eindhoven (NL); Radu Serban Jasinschi, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/294,247

(22) PCT Filed: Mar. 28, 2007
(86) PCT No.: PCT/IB07/51098

§ 371 Date: Sep. 24, 2008

(30) Foreign Application Priority Data
Mar. 29, 2006 (EP) 06300302.4

(51) Int. Cl. G06K 9/40

(52) U.S. Cl. 382/254

(57) ABSTRACT

The present invention relates to an image processing system where processing modules are used for processing an incoming image-in signal (101) in at least a first layer and a second layer, wherein the processing results in at least first and second processed image signals. A signal analyzer (111) determines one or more image-control parameters (121, 122) from the image-in signal and uses the control parameters to operate a combination circuit (120) in combining the processed image signals into an image-out signal (102).

### FIELD OF THE INVENTION

The present invention relates to a method and a system for improving visual quality of an image signal by processing the image signal in at least a first and a second layer, respectively, and subsequently combining the processed image signals into a single image-out signal.

### BACKGROUND OF THE INVENTION

Low-bitrate compressed video streams often look awful, especially on high TV sets, where blocking and so-called mosquito's artifacts are the most disturbing artifacts. Generally, for removing certain types of artifacts, the original image-in signal is processed by removing a certain type of artifacts, i.e. a kind of a filtering process is performed where certain types of artifacts are removed. This means of course that the processed signal, compared to the original signal, lacks data, e.g. there may be pixels in the Y, U and/or V components where important properties, e.g. the sharpness, may be greatly vanished.

Mosquito artifact and blocking artifact reduction algorithms have been developed for removing the blocking and mosquito's artifacts. By applying only one of these two algorithms on an image-in signal, only one of the two artifacts can be removed, i.e. either the blocking artifacts or the mosquito's artifacts. Attempts have been made to remove both these types of artifacts by applying the two algorithms in a cascade way fashion on an original image-in signal, i.e. by first applying a first algorithm for removing the first type of artifacts (e.g. mosquito's artifacts), and subsequently applying a second algorithm on the already processed signal for removing the second type of artifacts (e.g. blocking artifacts).

However, applying the algorithms in such a cascade way fashion has the drawback that after applying the first algorithm, data will be removed that the subsequent algorithm might benefit from, or that might even be essential for the subsequent algorithm. This can obviously easily result in that the image-out signal from the subsequent algorithm is of a lower quality than the original image-in signal, i.e. the processed image will be worse than the original image.

### BRIEF DESCRIPTION OF THE INVENTION

The object of the present invention is to overcome said problems by providing a method and a system for image processing that enables multiple processing steps, where each processing step is performed on the original image-in signal, and wherein the resulting processed image signals are combined into a single image-out signal in the most optimal way.

According to one aspect, the present invention relates to a method of image processing comprising:

(a) processing an incoming image-in signal in at least a first layer and a second layer, said processing resulting in at least a first and a second processed image signal respectively;
(b) determining one or more image-control parameters from one or more of said signals and
(c) combining said processed image signals into an image-out signal using said one or more image-control parameters as operation parameters.

Accordingly, since said processing steps are performed in a parallel-way fashion, and not in a cascade way fashion, it is ensured that in each processing step the original image-in signal is being processed and not a processed image signal with changed properties (e.g. brightness and/or color values) as would be the case in the cascade way fashion processing. The result of each respective processing steps is thereby optimized since each processing step processes the original image-in signal, and not a processed signal. Furthermore, said one or more operation parameters provide an important tool that enables combining the processed image signals into said single image-out signal in the most optimal way. The result is clearly an output picture of higher quality than the original picture.

In one embodiment, the step of determining said one or more image-control parameters from one or more of said signals comprises determining said image-control parameters from the image-in signal. In another embodiment, the step of determining said one or more image-control parameters from one or more of said signals comprises determining said image-control parameters from the processed image signals. In yet another embodiment, the step of determining said one or more image-control parameters from one or more of said signals comprises determining said image-control parameters from the image-in signal and from the processed image signals. In that way, different possibilities are provided of determining the image-control parameters since in some scenarios it might be preferred to determine them form the image-in signal, in some scenarios it might be preferred to determine them from the image-out signal, and in some scenarios it might be preferred to used a “combination” image-control parameters determined from the image-in and image-out signals.

In an embodiment, processing said incoming image-in signal in said at least first and second layers further comprises determining statistical data from the processed image signals, said statistical data being used as additional operation parameters for combining said processed image signals into said single image-out signal. An example of such statistical data is the presence of block artifacts, e.g. “weak”, “medium” and “strong”.

In an embodiment, determining said one or more image-control parameters from said one or more signals comprises determining spatial image gradients of a texture component of the image of said one or more signals.

In an embodiment, determining said one or more image-control parameters from said one or more signals comprises determining weighted image gradient value per pixel within an image block representing an average energy of image gradients of a texture component of the image of said one or more signals.

In an embodiment, determining said one or more image-control parameters from said one or more signals comprises determining an average value and variance value per image block representing an average energy of image gradients of a texture component of the image of said one or more signals.

In an embodiment, the step of processing the incoming image-in signal in said at least first and second layers further comprises additionally processing a processed image signal in at least one of said at least first and second layers. Accordingly, this enables cascaded processing in one or more of said layers, e.g. first by applying a de-blocking algorithm and subsequently a de-mosquito algorithm, or vice versa, within the same layer.

According to another aspect, the present invention relates to a computer readable media for storing instructions for enabling a processing unit to execute the above method steps.

According to yet another aspect the present invention relates to an image processing system comprising:

(a) processing modules for processing an incoming image-in signal in at least a first and a second layers, said processing resulting in at least a first and a second processed image signals,
(b) a signal analyzer for determining one or more image-control parameters from one or more of said signals, and
(c) a combination circuit operated by said signal analyzer for combining said processed image signals into an image-out signal, wherein said operation is based on using said one or more image-control parameters as operation parameters.

### BRIEF DESCRIPTION OF THE DRAWINGS

Embodiments of the invention will be described, by way of example only, with reference to the drawings, in which:

FIG. 1 shows an image processing system according to the present invention,

FIG. 2 shows the directions used for computing the image gradients to be used as control parameters,

FIG. 3 shows an embodiment of a two layered system according to the present invention, and

FIG. 4 shows a method of image processing according to the present invention.

### DESCRIPTION OF EMBODIMENTS

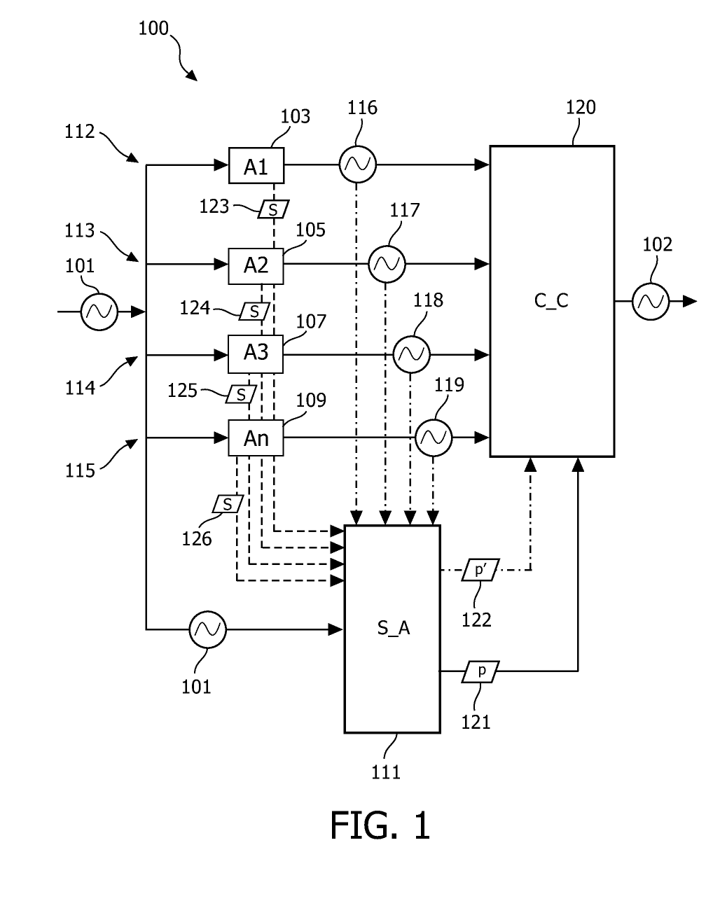

FIG. 1 shows an image processing system 100 according to the present invention, wherein the system comprises processing modules 103, 105, 107, 109, a signal analyzer 111 and a combination circuit 120. The system 100 can be a video receiver component of any number of different electronic devices such as HDTV mainstream and high end TVs as well as DVD+RW players, or the like. In particular, in the system 100, an image-in 101 signal may be the output of a video decoder, e.g. an MPEG-2 decoder. Optionally, if mixed signals are received, such as from PCI or Ethernet connection, there might be an optional digital decode module.

As shown here, the image-in signal 101 is processed in a number of layers 112, 113, 114, 115 in a “parallel way fashion” by the processing modules 103, 105, 107, 109, which independently process the original image-in signal 101, said processing resulting in processed image signals 116, 117, 118, 119. The term “processing” can relate to a filtering process applied on the original image-in signal 101 for removing certain unwanted features and/or artifacts, e.g. the processing can relate to any kind of post processing algorithms such as de-blocking algorithm from removing blocking artifacts, or de-mosquito algorithm for removing mosquito artifacts. The processed image signals 116-119 are accordingly image signals that lack any of said features compared to the original image-in signal 101. The processing step performed by each respective processing module is followed by pre-defined instructions in a computer program that can be integrated into the hardware of the system, or embedded to the system, or an external computer program.

The signal analyzer 111 is adapted to determine, from the original image-in signal 101, one or more image-control parameters 121, and further to operate the combination circuit 120 where the processed image signals 116-119 are combined into a single image-out signal 102. The signal analyzer 111 is further adapted to determine from the processed image signals 116-119 one or more image-control parameters 122, in addition to, or instead of, said image-control parameters 121 obtained from the original image-in signal 101. This might be an advantage e.g. in cases where the coding artifacts might trigger wrong decisions.

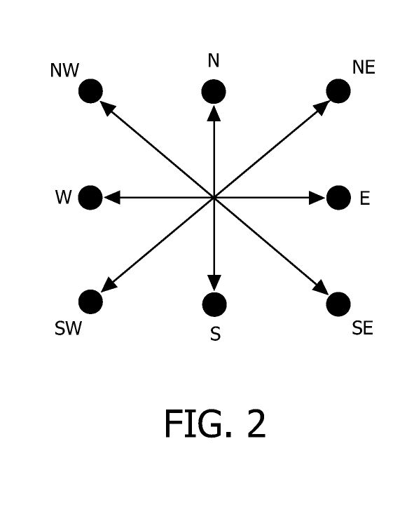

In an advantageous embodiment, the one or more image-control parameters 121, 122 comprise spatial image gradients of a texture component of the image of said image-in signal 101 and/or the processed image signals 116-119. These may e.g. comprise a collection of directional image gradients in different directions: vertical, horizontal, and two diagonal directions (45° and 135°). Gradients along four different directions: (i) north-south (NS); (ii) east-west (EW); (iii) northwest-southeast (NWSE), and (iv) northeast-southwest (NESW), as shown in FIG. 2. Further, the spatial derivatives use the following masks along these four directions:

$${M}_{NS} = [ \begin{matrix}1 & 1 & 1 \\ 0 & 0 & 0 \\ - 1 & - 1 & - 1\end{matrix} ]$$

$${M}_{EW} = [ \begin{matrix}1 & 0 & - 1 \\ 1 & 0 & - 1 \\ 1 & 0 & - 1\end{matrix} ]$$

$${M}_{NWSE} = [ \begin{matrix}1 & 1 & 0 \\ 1 & 0 & - 1 \\ 0 & - 1 & - 1\end{matrix} ]$$

$${M}_{NESW} = [ \begin{matrix}0 & 1 & 1 \\ - 1 & 0 & 1 \\ - 1 & - 1 & 0\end{matrix} ]$$

Using these four masks, the spatial image gradients of the image can be computed:

I_{NS}(x,y)=M_{NS}*I(x,y)

I_{EW}(x,y)=M_{EW}*I(x,y)

I_{NWSE}(x,y)=M_{NWSE}*I(x,y)

I_{NESW}(x,y)=M_{NESW}*I(x,y)

with I(x,y) as the spatial image gradient.

In an embodiment, the one or more image-control parameters 121, 122 comprise determining weighted image gradient value per pixel within an image block representing an average energy of image gradients of a texture component of the image of said image-in signal 101 and/or the processed image signals 116-119. This can be done by squaring the pixel-based image gradients, summing up over all directions (divided by 4), normalized, and taking the square root. Thus,

$$P ( x , y ) = \frac{1}{\sqrt{2}} \times \sqrt{\begin{matrix}{I}_{NS} \times {I}_{NS} + {I}_{EW} \times {I}_{EW} + \\ {I}_{NWSE} \times {I}_{NWSE} + {I}_{NESW} \times {I}_{NESW}\end{matrix}} ,$$

where I_{NS}≡I_{NS}(x,y), and so forth, and P(x,y) represents the average image gradient per pixel. Indeed, P(x,y) represents the normalized square root of the image gradient energy. Given the weighted image gradient P(x,y) per image pixel, a first order statistics per a given square block can be thus computed. The average computation is the first order statistics computation. This may be realized in accordance with the following in computing the average for each N×N block:

$$〈 P 〉 = {\sum }_{i} P ( {x}_{i} , {y}_{i} ) / ( N \times N )$$

In an embodiment, the one or more image-control parameters 121, 122 comprise weighted image gradient value per pixel within an image block representing an average energy of image gradients of a texture component of the image of said image-in signal 101 and/or the processed image signals 116-119. Given the weighted image gradient P(x,y) per image pixel, a second order statistics per a given square block can be thus computed, which gives the variance. Thus, the variance within a N×N block can be computed by:

$$Δ P = \sqrt{( P ( x , y ) - 〈 P 〉 ) \times ( P ( x , y ) - 〈 P 〉 )} / ( N \times N )$$

However, using other types of computations is also possible, such as computation of third order statistics and above.

In an embodiment, the processing of the incoming image-in signal 101 in said at least first and second layers 112-115 further relates in statistical data 123-126 that are adapted to be used as additional operation parameters for combining said processed image signals 116-119 into said single image-out signal 102. These statistical data could e.g. be useful in ranking the processing steps.

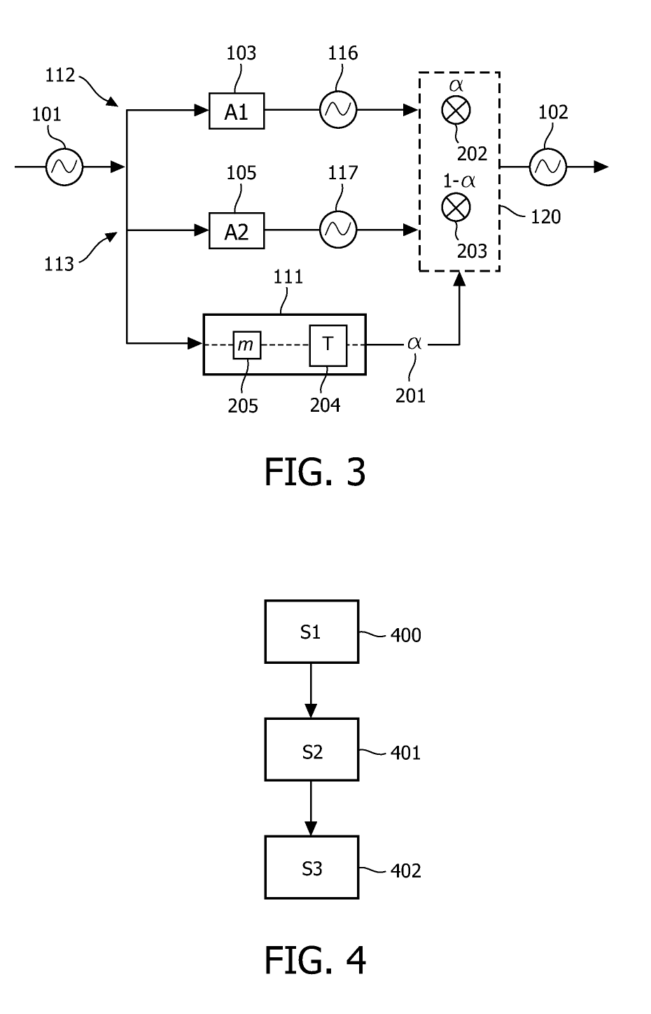

FIG. 3 shows an embodiment of a two layered 112-113 system, each layer comprising a single processing module 103, 105 for processing, respectively, an image-in signal 101. The processing could e.g. comprise applying de-blocking and de-mosquito algorithms in each respective layer, wherein the resulting processed signals 116, 117 would be signals where data relating to blocking and mosquito artifacts have been removed.

In this embodiment the signal analyzer 111 determines the image-control parameter 201 by first calculating a metric signal m 205, (e.g. said spatial image gradients and/or said weighted image gradient value per pixel within an image block and/or said average value and variance value per image block) from the image-in signal 101, and implements a table look-up technique 204 for determining one or more image-control parameters 201. As illustrated here, the image-control parameter 201 comprises a single control parameter α which is determined from the image-in signal 101 and is sent to the combination circuit 120 including two multipliers 202 and 203 (by α and 1−α, respectively). As an example 0≦α≦1 and could represent a kind of weight value of a preferred combination of the processed signals, i.e., if e.g. α=0.5, the processed image signals are to be combined evenly, whereas if e.g. α=0.8, the processed image signal 116 has larger relevance than processed image signal 117, namely 80% vs. 20% for the image signal 117. The following example shows how the control parameter α could be determined from the metric signal m

m1=10; g1=0.25,
m2=15; g2=0.5,
m3=20; g3=0.75,
m4=30, g4=1.0.
gainmin=0.0
gain=0.0;
if (m>m1) {gain=g1;}
if (m>m2) {gain=g2;}
if (m>m3) {gain=g3;}
if (m>m4) {gain=g4;}
if (gain<gainmin) {gain=gainmin;}
α=gain.

FIG. 4 shows a method according to the present invention of image processing, where an incoming image-in signal is processed (S1) 400 in at least a first layer and a second layer wherein the processing results in at least first and second processed image signals.

For combining the processed image signals into an image-out signal in the most optimal way, one or more image-control parameters are determined (S2) 401 from the image-in signal. These can e.g. comprise spatial image gradients of a texture component of the image of said image-in signal and/or from the processed image signals, or the weighted image gradient value per pixel within an image block representing an average energy of image gradients of a texture component of the image of said image-in signal and/or from the processed image signals, or an average value and variance value per image block representing an average energy of image gradients of a texture component of the image of said image-in signal and/or from the processed image signals.

Finally, the processed image signals are combined into said image-out signal (S3) 402 using the one or more image-control parameters as operation parameters.

In an embodiment, the step of processing the image-in signal comprises applying various post processing algorithms in each of said layers in a “parallel way fashion”. As an example, the number of layers could be two, and the algorithms applied could be a mosquito artifact reduction algorithm for removing mosquito artifacts in one of said layers and a blocking artifact algorithm for removing blocking artifacts the other layer (see FIG. 2).

In another embodiment, the processing step in one or more of said layers further comprises adding at least a second processing step, i.e. combining the processing in a cascaded fashion. As an example, in a first layer a mosquito artifact reduction could applied on the image-in signal, and subsequently in the same layer an blocking artifact algorithm could be applied on the processed signal.

In the description given above, the term “image” should be understood in a broad sense. This term includes a frame, a field, and any other entity that may wholly or partially constitute a picture. Moreover, there are numerous ways of implementing functions by means of items of hardware or software, or both. In this respect, the drawings are very diagrammatic and represent only possible embodiments of the invention. Thus, although a drawing shows different functions as different blocks, this by no means excludes that a single item of hardware or software carries out several functions. Nor does it exclude that an assembly of items of hardware or software or both carry out a function.

The remarks made herein before demonstrate that the detailed description, with reference to the drawings, illustrates rather than limits the invention. There are numerous alternatives, which fall within the scope of the appended claims. Any reference sign in a claim should not be construed as limiting the claim. The word “comprising” does not exclude the presence of other elements or steps than those listed in a claim. The word “a” or “an” preceding an element or step does not exclude the presence of a plurality of such elements or steps.

1. A method of image processing comprising:
(a) processing (400) an incoming image-in signal (101) in at least a first layer and a second layer (112-115), said processing resulting in at least a first and a second processed image signal (116-119) respectively;
(b) determining (401) one or more image-control parameters (121, 122) from one or more of said signals (101, 116-119); and
(c) combining (402) said processed image signals (116-119) into an image-out signal (102) using said one or more image-control parameters (121, 122) as operation parameters.

2. A method according to claim 1, wherein the step of determining (401) said one or more image-control parameters (121, 122) from one or more of said signals (101, 116-119) comprises determining said image-control parameters (121, 122) from the image-in signal (101).

3. A method according to claim 1, wherein the step of determining (401) said one or more image-control parameters (121, 122) from one or more of said signals (101, 116-119) comprises determining said image-control parameters (121, 122) from the processed image signals (116-119).

4. A method according to claim 1, wherein the step of determining (401) said one or more image-control parameters (121, 122) from one or more of said signals (101, 116-119) comprises determining said image-control parameters (121, 122) from the image-in signal (101) and from the processed image signals (116-119).

5. A method according to claim 1, wherein processing (400) said incoming image-in signal (101) in said at least first and second layers (112-115) further comprises determining statistical data (123-126), said statistical data being used as additional operation parameters for combining said processed image signals (116-119) into said single image-out signal (102).

6. A method according to claim 1, wherein determining said one or more image-control parameters (121, 122) from said one or more signals (101, 116-119) comprises determining spatial image gradients of a texture component of the image of said one or more signals (101, 116-119).

7. A method according to claim 1, wherein determining said one or more image-control parameters (121, 122) from said one or more signals (101, 116-119) comprises determining weighted image gradient value per pixel within an image block representing an average energy of image gradients of a texture component of the image of said one or more signals (101, 116-119).

8. A method according to claim 1, wherein determining said one or more image-control parameters (121, 122) from said one or more signals (101, 116-119) comprises determining an average value and variance value per image block representing an average energy of image gradients of a texture component of the image of said one or more signals (101, 116-119).

9. A method according to claim 1, wherein the step of processing (400) the incoming image-in signal (101) in said at least a first and a second layers (112-115) further comprises processing additionally a processed image signals (116-119) in at least one of said at least first and second layers (112-115).

10. A computer readable media for storing instructions for enabling a processing unit to execute the method steps in claim 1.

11. An image processing system comprising:
(a) processing modules (103, 105, 107, 109) for processing an incoming image-in signal (101) in at least a first layer and a second layer (112-115), said processing resulting in at least first and second processed image signals (116-119), respectively;
(b) a signal analyzer (111) for determining one or more image-control parameters (121, 122) from one or more of said signals (101, 116-119); and
(c) a combination circuit (120) operated by said signal analyzer (111) for combining said processed image signals (116-119) into an image-out signal (102), wherein said operation is based on using said one or more image-control parameters (121, 122) as operation parameters.
